(19) United States
(12) Patent Application Publication
(10) Pub. No.: US 2016/0232616 A1
(43) Pub. Date: Aug. 11, 2016

(54) Systems and Methods for Insurance Design Using Standard Insurance Contexts and Factors

(71) Applicant: eBao Tech Corporation, Shanghai (CN)

(72) Inventor: Weiliang LE, Shanghai (CN)

(21) Appl. No.: 14/379,634

(22) PCT Filed: Aug. 23, 2013
(86) PCT No.: PCT/CN2013/082212

§ 371 Date: Aug. 19, 2014

(51) Int. Cl. G06Q 40/08

(52) U.S. Cl. CPC G06Q 40/08

(57) ABSTRACT

A computer-implemented method for creating an insurance design is disclosed, The method includes defining a plurality of factors, and associating the plurality of factors with at least one insurance context. The method further includes providing a list of associated factors upon a selection of the insurance context. Computer-implemented method for creating an insurance coverage and an insurance product are also disclosed. The methods include providing a list of factors associated with a plurality of user-selected insurance contexts, and determining the insurance coverage or insurance product based on the list of factors.

### DESCRIPTION OF THE DISCLOSURE

1. Field of the Disclosure

This disclosure relates to systems and methods for insurance designs and, more particularly, to systems and methods for insurance designs using standard insurance contexts and factors.

2. Background of the Disclosure

The insurance industry considers a plurality of variable factors in designing and marketing different insurance products. For example, different factors may be used in designing insurance products offered to different insured objects and/or geographic regions. To accommodate variations and changes in customer and market needs, insurance companies may need to constantly design new insurance coverages for various incidents and new insurance products for various insured objects. For example, if a market opportunity comes up, an insurance company may want to redesign its insurance coverage and develop a new insurance product to take advantage of such market opportunity.

However, with existing insurance design systems, the design/redesign process is typically complex and time-consuming. A product has to be rebuilt from bottom up to respond to each market need and change. As a result, a large number of products with no structured relations with each other may be created, and very soon it becomes inevitably hard to manage these products. For example, in response to a small change of market or risk pattern, an insurance company may need to recreate the new insurance coverage and design the new insurance product from scratch. For example, using existing insurance design systems, it may take about several months for some insurance companies to design a new product and distribute the newly designed products to the market. The delay contributes to inefficiency and lost market opportunities.

To improve the speed of insurance product design, a method has been developed that predefines various insurance coverages and creates insurance products based on these predefined insurance coverages. However, using such a method, a new insurance coverage has to be created in response to a market change, even if a minor one. Then the newly created insurance coverage has to be added to the list of predefined insurance coverages, and the subsequent insurance product design has to be updated accordingly. Since the insurance products and various coverages have no structured relations with each other, the design process becomes inevitably difficult to manage. The process could be complicated and time consuming. Therefore, although predefining and storing insurance coverages may save the time to assemble an insurance product, it still does not efficiently response to market changes. In fact, the task of predefining and managing these unstructured insurance coverages is very complex and still time consuming.

Therefore, there is a need to go one or more levels below coverage to standardize the insurance product design process based on standardized insurance contexts and factors. There is also a need to use these standardized insurance contexts and factors to efficiently assemble and segment insurance products from coverages. There is yet another need to generate various insurance related templates based on these standardized insurance contexts and factors in order to fast deploy the products into the insurance production system. It is an objective of the present invention to improve insurance product design and deployment such that the insurance products respond to the fast-changing market in a real time manner.

### SUMMARY

Various insurance products may be designed to cover different perils and damages. For examples, an auto product may include coverage to cover auto damages caused by fire or third party liabilities caused by collision. Insurance management may include different phases such as, for example, product design, product distribution, and policy life cycle management including sales, renew, endorsement, and claim. Risk and risk management stay at the center of the insurance industry. When an insurance event happens, its cause (peril) may vary case by case, and the caused damage may be of different types and different significances, However, for an insurance product line of business, such as automobile insurance, perils to cover are limited in number and can be standardized. Further, upon the occurrence of a particular peril, types of potential damages are limited in number and can be standardized. Also, for a particular peril and a particular damage, the associated risk factors, which are used to determine the likelihood of peril(s) as well as the potential scope of damage, are stable and finite in number and thus, can be standardized as well. For an insurance coverage, the covered peril(s) and damage(s) are the foundational elements that define and size the risk of the coverage along with indemnification.

The current disclosure describes systems and methods to pre-establish, standardize and manage basic insurance contexts and factors, and then to create coverage using these basic elements. As a result, the number of distinct coverages can be kept small and differences among these coverages are well structured and easily managed. Insurance products may then be assembled and segmented using these risk factors in respond to the market changes, so that real time insurance product design can be achieve.

In one aspect, a computer-implemented method for creating an insurance design is disclosed. The method includes defining a plurality of factors, and associating the plurality of factors with at least one insurance context. The method further includes providing a list of associated factors upon a selection of the insurance context.

In another aspect, a computer-implemented method for creating an insurance coverage is disclosed. The method includes providing a list of factors associated with a plurality of user-selected insurance contexts, and determining the insurance coverage based on the list of factors.

In yet another aspect, a computer-implemented method for creating an insurance product is disclosed. The method includes providing a list of factors associated with a plurality of user-selected insurance contexts, and determining an insurance coverage and an insured object based on the list of factors. The method further includes creating the insurance product by combining the insurance coverage with the insured object.

In yet another aspect, a computer-implemented method for creating an insurance product is disclosed. The computer-implemented method includes providing a list of factors. The method further includes creating a first insurance product based on the list of factors, and creating a second insurance product by segmenting the first insurance product based on a subset of the list of factors.

In yet another aspect, a computer-implemented method for generating an insurance-related template is disclosed. The computer-implemented method includes providing a list of factors associated with a plurality of user-selected insurance contexts. The method further includes generating the insurance-related template based on the list of factors.

In yet another aspect, a computer-implemented method for generating an insurance policy model is disclosed. The computer-implemented method includes receiving values of a list of factors, the list of factors associated with a plurality of user-selected insurance contexts. The method further includes generating the insurance policy model based on the values of the list of factors and an insurance policy model template, the insurance policy model template created based on the list of factors. In some embodiments, the method also includes performing an insurance calculation by applying the values to a formula, where the formula is determined based on the list of factors. In some embodiments, the insurance calculation calculates one of an insurance premium, an insurance commission, or an insurance discount

In yet another aspect, a computer-implemented method for processing an insurance application is disclosed. The method includes receiving values of a list of factors, the list of factors associated with a plurality of user-selected insurance contexts. The method further includes determining whether to accept, reject, or perform a predefined processing on the insurance application based on the values and a rule, the rule determined based on the list of factors.

In yet another aspect, a computer-implemented method for generating insurance analytics is disclosed. The computer-implemented method includes receiving values of a list of factors used in a plurality of insurance policies the list of factors associated with a plurality of user-selected insurance contexts. The method further includes generating insurance analytics based on the values.

It is to be understood that both the foregoing general descriptions and the following detailed descriptions are exemplary and explanatory only and are not restrictive of the invention, as claimed.

Although the disclosed embodiments are discussed primarily in the context of creating and managing insurance products, other applications are contemplated. For example, the disclosed embodiments may be used for processing other insurance-related transactions based on the created insurance product. As another example, the disclosed embodiments may also be used for creating virtual products other than insurance products.

### BRIEF DESCRIPTION OF THE DRAWINGS

The accompanying drawings, which are incorporated in and constitute a part of this specification, illustrate embodiments and, together with the description, serve to explain principles of the invention.

FIG. 1 is a block diagram of an exemplary insurance design system, according to some disclosed embodiments.

FIG. 2 illustrates a block diagram of an exemplary computing system, according to some disclosed embodiments.

FIG. 3 illustrates an architectural diagram of an exemplary process for creating and managing insurance products, according to some disclosed embodiments.

FIG. 4 illustrates a flow chart of an exemplary process for creating an insurance design, according to some disclosed embodiments.

FIGS. 5A and 5B each illustrate a table including a plurality of exemplary factors associated with insurance contexts, according to some disclosed embodiments.

FIG. 6 illustrates a flow diagram of an exemplary process for creating insurance products from standard factors, according to some disclosed embodiments.

FIG. 7 illustrates exemplary associations among peril, damage, indemnity, and standard factors, according to some disclosed embodiments.

FIG. 8 illustrates a flow chart of an exemplary process for creating an insurance coverage, according to some disclosed embodiments.

FIGS. 9A and 9B each illustrate an exemplary interface for creating an insurance coverage, according to some disclosed embodiments.

FIG. 10 illustrates an exemplary interface for creating a formula for insurance coverage, according to some disclosed embodiments.

FIG. 11 illustrates a flow chart of an exemplary process for creating an actuary insurance product, according to some disclosed embodiments.

FIG. 12 illustrates an exemplary interface for creating an actuary insurance product, according to some disclosed embodiments.

FIG. 13 illustrates a flow chart of an exemplary process for creating a marketable insurance product, according to some disclosed embodiments.

FIG. 14 illustrates an exemplary interface for creating a marketable insurance product, according to some disclosed embodiments.

FIG. 15 illustrates a table containing exemplary predetermined factors for segmenting an actuary product, according to some disclosed embodiments.

FIG. 16 illustrates a flow diagram for creating various insurance-related templates and other documents, according to some disclosed embodiments.

FIG. 17 illustrates a flow chart of an exemplary process for processing an insurance application/claim, according to some disclosed embodiments.

FIG. 18 illustrates a flow chart of an exemplary process for creating an insurance policy, according to some disclosed embodiments.

FIG. 19 illustrates a flow chart of an exemplary process for creating insurance analytics, according to some disclosed embodiments.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of systems and methods consistent with aspects related to the invention as recited in the appended claims.

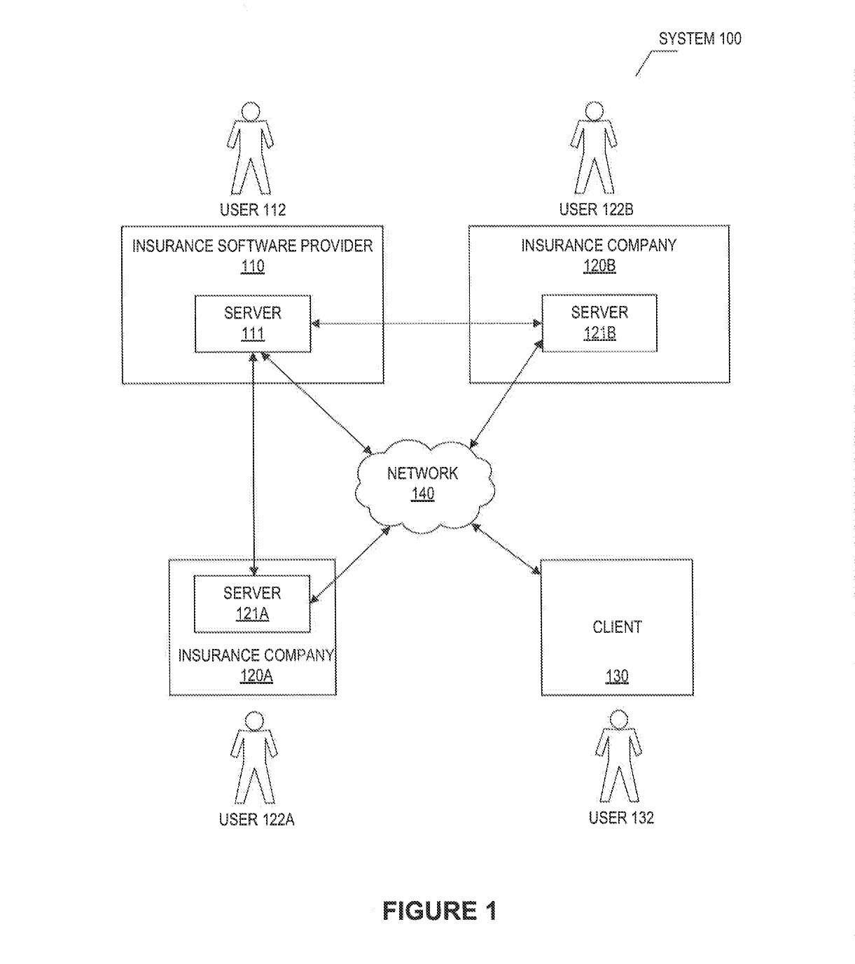

FIG. 1 is a block diagram of an insurance design system 100, according to some disclosed embodiments. In some embodiments, system 100 may include an insurance software provider 110, insurance companies 120A and 120B, a client 130, and a network 140. It is contemplated that the components and arrangement of the components included in system 100 may vary. For example, system 100 may further include other components that perform or assist in the performance of one or more processes consistent with the disclosed embodiments.

Insurance software provider 110 may be an entity that provides insurance design software, For example, insurance software provider 110 may be a software design company that designs, generates, provides, manages, and/or maintains insurance products to be used by insurance companies 120A and 120B. In some embodiments, insurance software provider 110 may custom-design insurance software products based on special requests from insurance companies 120A and 120B.

Insurance software provider 110 may include one or more computing systems that are configured to execute software instructions stored on one or more memory devices to perform one or more operations consistent with the disclosed embodiments. In one embodiment, insurance software provider 110 may include server 111.

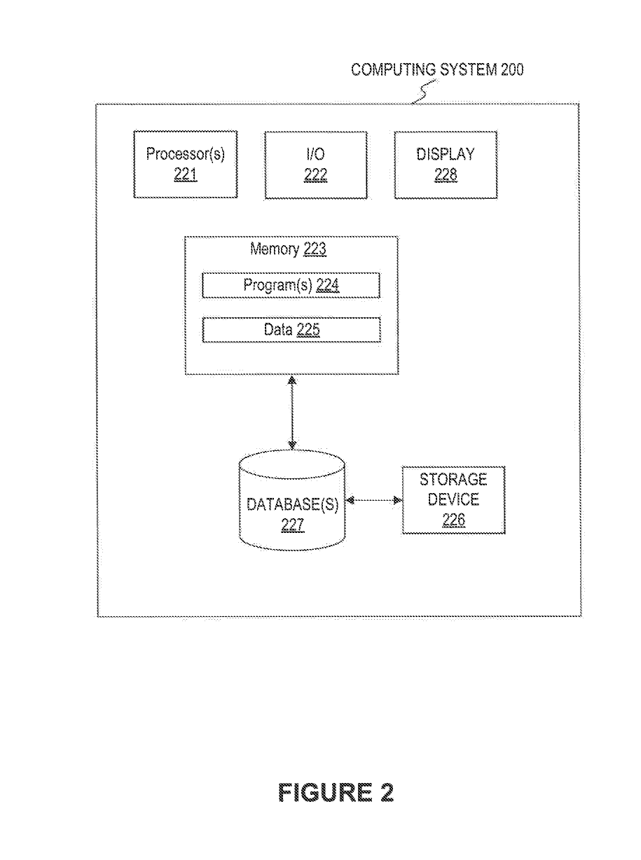

Server 111 may be a general-purpose computer, a mainframe computer, or any combination thereof. For example, FIG. 2 illustrates an exemplary computing system 200 that can be implemented as server 111. For example, server 111 may include one or more memory devices 223 configured to store software instructions/programs 224 and data 225, including metadata for insurance design. Additional programs and data may also be stored in storage device 226. In some embodiments, data 225 may be stored as a database 227 coupled to memory 223 and storage device 226.

Sever 111 may further include one or more processors 221 configured to use the data and execute the software instructions to perform server-based functions and operations. For example, processor 221 may be configured to execute stored software instructions to perform operations associated with providing software for insurance companies to design and manage insurance products in a manner consistent with the disclosed embodiments.

Server 111 may be a standalone server, or may be part of a subsystem, which may be part of a larger system. For example, server 111 may be among a group of distributed servers that are remotely located and communicate over a network (e.g., network 140) or a dedicated network, such as a LAN. As another example, server 111 may be part of server 121A or 121B.

In certain embodiments, a user 112 may operate one or more components of insurance software provider 110 (e.g., server 111) to perform one or more operations consistent with the disclosed embodiments. For example, user 112 may operate server 111 via input/output interface 222, and receive processing results from display 228. In one aspect, user 112 may be someone authorized to use components of server 111 or perform processes for insurance software provider 110. For example, user 112 may be an employee of, or otherwise associated with, insurance software provider 110.

In some embodiments, insurance companies 120A and 120B may be entities that provide insurance services consistent with the disclosed embodiments. In some embodiments, insurance company 120A and insurance company 120B may be entities that purchase insurance software products offered by insurance software provider 110, and use the software products to create and manage insurance products. For descriptive purposes only, the descriptions below refer only to insurance company 120A, but it is contemplated system 100 is not limited to one insurance company. Insurance company 120B may have same or similar components (e.g., server 121B may be the same as or similar to server 121A) as those provided by insurance company 120A, and may perform same or similar functions as those described with respect to insurance company 120A.

Insurance company 120A may operate brick and mortar location(s) that a consumer (e.g., user 132) may physically visit and purchase insurance goods and services, Such physical locations may have on-site computing devices that perform insurance service transactions with consumers, They may also have back-end and/or front-end computing components that store insurance-system-related data and execute software instructions to perform operations consistent with the disclosed embodiments. These computing components may be computers that are operated by employees of insurance company 120A (e.g., back-office systems, etc,). In certain embodiments, insurance company 120A may also include entities that provide electronic mechanisms, such as a website or a similar online location that consumers (e.g., user 132) may access using a computer (e.g., client 130) through browser software or similar software.

Insurance company 120A may operate a server 121A. Similar to sever 111, server 121A may be a computing device such as computing device 200 illustrated in FIG. 2. For example, server 121A may include one or more memory devices 223 storing software instructions/programs 224, such as insurance software provided by insurance software provider 110. Memory device 223 may further store data 225, including metadata for insurance design and values for the metadata to create an insurance policy, Server 121A may further include processor 221 configured to execute stored software instructions to perform operations associated with creating and managing insurance products.

According to some embodiments, server 121A may be configured to communicate with server 111 to receive data associated with creating and managing insurance products stored in one or more memory devices of server 111. In some embodiments, server 121A may access and execute insurance design software and data stored remotely, such as on sever 111. In some embodiments, server 121A may use cloud computing and let a remote server (e.g., server 111) execute insurance design software stored thereon and send the results to sever 121A. In some embodiments, server 121A may include server 111, or perform the functions of server 111.

In some exemplary embodiments, a user 122A may operate server 121A to perform one or more operations consistent with the disclosed embodiments. For example, user 122A may be someone authorized to use components of server 121A or perform processes for insurance company 120A consistent with the disclosed embodiments. For example, user 122A may be an employee of, or otherwise associated with, insurance company 120A.

Client 130 may be a computing device configured to execute software instructions for performing one or more operations consistent with the disclosed embodiments, For example, client 130 may be a desktop computer, a laptop, a server, a mobile device (e.g., tablet, smartphone, etc.) and/or any other type of computing device. In some embodiments, client 130 may have components and configurations as those illustrated in FIG. 2 for computing system 200, For example, client 130 may include one or more processors 221 configured to execute software instructions stored in memory 223. In some embodiments, client 130 may include software that, when executed by a processor, performs Internet-related communications and content display processes. For instance, client 130 may execute browser software that generates and displays interfaces on display device 228 included in, or connected to, client 130.

In some embodiments, client 130 may have insurance design software installed thereon for creating and managing insurance products. For example, insurance software provider 110 may provide a copy of the insurance design software to chant 130 directly or indirectly through insurance company 120A/120B.

In some embodiments, a user 132 may use client 130 to perform one or more operations consistent with the disclosed embodiments. In one aspect, user 132 may be a customer or an insurance agent of insurance company 120A and/or insurance company 120B. For instance, insurance company 120A and/or insurance company 120B may maintain an insurance service account for user 132. In some other embodiments, user 132 may not be affiliated with insurance company 120A and/or insurance company 120B from the perspective of user 132 and/or the perspective of insurance company 120A and/or insurance company 120B. For example, user 132 may be a beneficiary of an insurance product offered by insurance company 120A and/or insurance company 120B.

Network 140 may be any type of network configured to facilitate communications between the components of system 100. In some embodiments, network 140 may be the Internet, a Local Area Network, or other suitable connections that enable transmission of information among the components of system 100. In some other embodiments, one or more components of system 100 may communicate directly through a dedicated communication link(s), such as the exemplary link between insurance software provider 110 and insurance companies 120A and 120B.

FIG. 2 illustrates a block diagram of a computing system 200 that may correspond to anyone of servers 111, 121A, and 121B, and client 130, according to some disclosed embodiment. Computing system may include a processor 221, an input/output (I/O) device 222, a memory 223, a storage device 226, a database 227, and a display device 226.

Processor 221 may be one or more known processing devices, such as a microprocessor from the Pentium™ family manufactured by Intel™ or the Turion™ family manufactured by AMD™. Processor 221 may include a single core or multiple core processor system that provides the ability to perform parallel processing. For example, processor 221 may be a single core processor that is configured with virtual processing technologies. In certain embodiments, processor 221 may use logical processors to simultaneously execute and control multiple processes. Processor 221 may implement virtual machine technologies, or other similar known technologies, to provide the ability to execute, control, run, manipulate, store, etc., multiple software processes, applications, programs, etc. In another embodiment, processor 221 includes a multiple-core processor arrangement (e.g., dual or quad core) that is configured to provide parallel processing functionalities to allow computing system 200 to execute multiple processes simultaneously. One of ordinary skill in the art would understand that other types of processor arrangements could be implemented that provide for the capabilities disclosed herein.

Memory 223 may include one or more storage devices configured to store instructions used by processor 221 to perform functions related to the disclosed embodiments. For example, memory 223 may be configured with one or more software instructions, such as program 224 that may perform one or more operations when executed by processor 221. The disclosed embodiments are not limited to separate programs or computers configured to perform dedicated tasks. For example, memory 223 may include a single program 224 that performs the functions of computing system 200, or program 224 could comprise multiple programs. Additionally, processor 221 may execute one or more programs located remotely from server 211.

Memory 223 may also store data 225 that may reflect any type of information in any format that insurance software provider 110 may use to perform functions consistent with the disclosed embodiments. For example, data 225 may include metadata of a plurality of standard factors associated with an insurance system of which a detailed description is provided below, and other data enabling processor 221 to perform functions including providing insurance software products for creating and managing insurance products, consistent with the disclosed embodiments.

I/O devices 222 may be configured to allow data to be received and/or transmitted by server 211. I/O devices 222 may include one or more digital and/or analog communication devices that allow computing system 200 to communicate with other machines and devices, such as insurance company 120A (via server 121A) and/or insurance company 120B (via server 121B).

Computing system 200 may also include or be communicatively connected to one or more of database 227 through network 140. By way of example, database 227 may include Oracle™ databases, Sybase™ databases, or other relational databases or non-relational databases, such as Hadoop sequence files, HBase, or Cassandra. In exemplary embodiments, database 227 may store metadata of standard factors to be used for insurance design. For example, the metadata may be created by user 112, and stored into database 227.

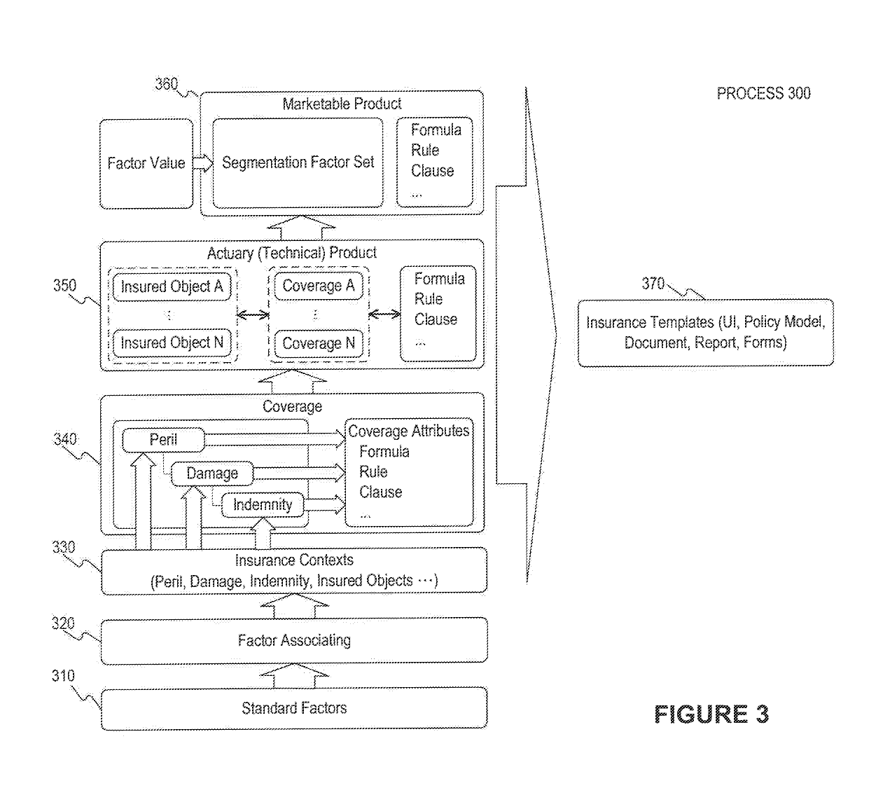

FIG. 3 illustrates an architectural diagram of an exemplary process 300 for creating and managing insurance products, according to some disclosed embodiments. In some embodiments, process 300 may embody the complete insurance design lifecycle, which includes various design phases performed by one or multiple people.

Process 300 may start with a phase 310 where standard factors are defined and stored. For example, insurance software provider 110 may define the factors. Consistent with this disclosure, a factor is the metadata associated with an or more insurance context (such as peril/damage with indemnity). In some embodiments, the factors may include actuary factors and non-actuary factors. Actuary factors may include factors that are considered by an actuary when calculating the premium of an insurance policy and evaluating the business rules to manage risk, Non-actuary factors may include factors that are not directly related to risk but may still affect the pricing of the insurance policy. For example, non-actuary factors may include marketing pricing factors, such as a competitor's premium for same or similar coverage. Such factors are normally not considered by actuaries but may still affect the insurance pricing. On the other hand, a person's name is not an actuary factor and does not affect pricing at all.

In some embodiments, insurance software provider 110 may further perform phase 320 to associate the factors with a plurality of insurance contexts, such that each insurance context may refer to a list of factors. For example, “fire,” as a type of peril, may refer to factors including location, building age, building area, number of bedrooms, construction type, wall construction type, roof construction type, etc.

In some embodiments, multiple insurance contexts may refer to a same factor. In such cases, the common factor is associated with each of the insurance contexts that refer to it. For example, “theft,” a type of peril for auto insurance may refer to the location of the owner, which is also a factor for “flood,” a type of peril for home insurance. Insurance software provider 110 may store the factors, as well as the association between the factors and the insurance contexts in a database, such as database 227 shown in FIG. 2.

Coverages, and other intermediate insurance attributes, such as rules, formulas, and clauses, may be created based on the factors and their associations to the insurance contexts. In some embodiments, insurance contexts such as standard peril, damage, indemnity, and insured objects may be first determined based on the factors, in phase 330. Then, insurance coverage may be determined by assembling the standard peril, damage, and indemnity, in phase 340. For example, insurance companies 120A and 120B may perform phases 330 and 340 using the software as well as the metadata (including the factors) provided by insurance software company 110.

Consistent with this disclosure, peril is a risk or incident that is covered by the insurance, such as fire (for a house), collision (for a car), and theft (for a personal property), Damage is the loss caused by associated peril. For example, vehicle property damage and personal medical damage may both occur in a collision accident, Indemnity is the extent that damage is covered by the insurance. In some embodiments, indemnity may include limits and deductibles. For example, an auto insurance policy may limit its payment to $100,000 any one accident (AOA).

As part of phase 330, insured objects may also be created. Consistent with this disclosure, an insured object is the object to which an insurance coverage applies. For example, the insured object in a home insurance policy may be a dwelling but on a specific piece of land. As another example, the insured object in an auto insurance policy may be one or more vehicles owned by a specific household. An insured object may be created based on actuary factors which are shared with related perils and damages, as well as additional non-actuary factors.

Insurance coverage, the indemnification for a specified damage caused by covered peril, may be assembled in phase 340 based on the peril, damage, and indemnification created in phase 330, Other elements, such as actuary formulas, rules, and clauses may also be created in phase 330. Consistent with this disclosure, an actuary formula is a mathematical formula used for computing an insurance premium based on various factors associated with the insurance contexts (e.g., peril, damage, indemnity, and insured object). A rule may specify one or more conditions for accepting or rejecting an insurance application. Typically, a rule may specify a range of values for a factor as a condition for accepting an insurance application. For example, a rule may be created to accept applications for people younger than 50 years old, or for houses that have smoke detectors installed, A clause may be a template language specifying certain insurance terms, or otherwise describing the insurance coverage.

In phase 350, an actuary insurance product (also known as a technical insurance product) may be created based on the coverages, the insured objects, and optionally the product level rules and formulas. For example, one or more insurance coverages may be combined with one or more insured objects to create the actuary product.

In phase 360, a marketable insurance product may be created, for example, by segmenting the actuary product created in phase 350. In some embodiments, the segmentation may be implemented as presetting values or ranges of values for certain factors associated with the actuary product. For example, the property location factor of a home insurance product may be preset to Virginia to target the Virginia residents as a potential market, such that sales and marketing efforts may be tailored for the Virginia market. As another example, the age factor of the covered person in a medical insurance product may be preset to 20-25 to target the young (typically single and/or with no kids) individuals, Such a product may be marketed to, for example, college students and new graduates.

In phase 370, various insurance related templates may be created based on the factors. In some embodiments, an interface may be created for receiving inputs of values for various factors associated with a particular insurance product. The interface may include various fields for receiving the inputs. In some embodiments, the interface may be a user interface (“UI”) or a graphic user interface (“GUI”) for receiving inputs from a user. In some other embodiments, the interface may be a programing interface for receiving input values from a public service. For example, the programing interface may be an application programing interface (“API”).

In some embodiments, an insurance policy model template may be created based on the associated factors in phase 360. Consistent with the present disclosure, an insurance policy model is an electronic version of an insurance policy that is created, stored, and modified on a computer. Further, an insurance policy model template is a template insurance policy model with fields to store values of the associated factors that are to be provided. When the fields are filled in with specific values, the insurance policy model template becomes an actual insurance policy model. Other template documents may also be created based on the associated factors in phase 360. For example, template reports, forms, and agreements may be created.

In other words, consistent with the present disclosure, factors and various insurance contexts, such as peril, damage, indemnity, and insured object, are the very basic “elements” for insurance design. Coverages are the “compounds” that are combinations of the basic “elements.” On the next level, actuary products are “mixtures” that are combinations of the coverages and insured objects. Just as a large number of mixtures may be created using the limited number of elements, a large number of actuary products may be created based on a limited number of factors. By predefining and storing a small number of “elements,” and assembling higher-level insurance semantics using these “elements,” the entire insurance design process may thus be simplified and expedited. The entire insurance life cycle may be efficiently and consistently managed among different people through the use of these predefined factors.

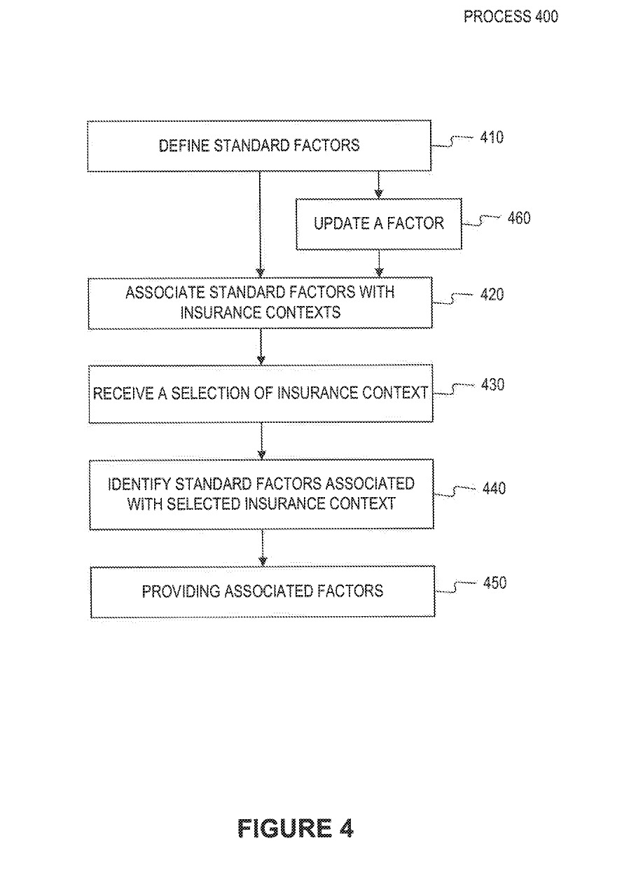

FIG. 4 illustrates a flow chart of an exemplary process 400 for creating an insurance design, according to some disclosed embodiments. For example, insurance software provider 110 may perform process 400. In step 410, insurance software provider 110 may predefine a list of standard factors. The factors may be selected based on empirical knowledge of insurance software provider 110, and/or based on feedback from insurance companies 120A and 120B. In some embodiments, each factor may be defined as a metadata class, which includes a factor ID, a factor name, a factor description, a data type, a business type, value option, etc.

In step 420, the list of standard factors may be associated with a plurality of insurance contexts. For example, the insurance contexts may include a peril/risk category, a damage/loss category, an indemnity category, and an insured object category. Each insurance context may refer to one or more standard factors predefined in step 410. In some embodiments, each insurance context may also be defined as a metadata class. For example, a peril class may include a peril ID, a peril name, and associated factor IDs.

In step 430, the predefined factors and their associations/relationships may be stored in a database as metadata. For example, insurance software provider 110 may use existing database management systems including, for example, Microsoft SQL Server, Microsoft Access, Oracle, FoxPro, My SQL, PostgreSQL, SQLite, etc., to create database 227 for storing the metadata.

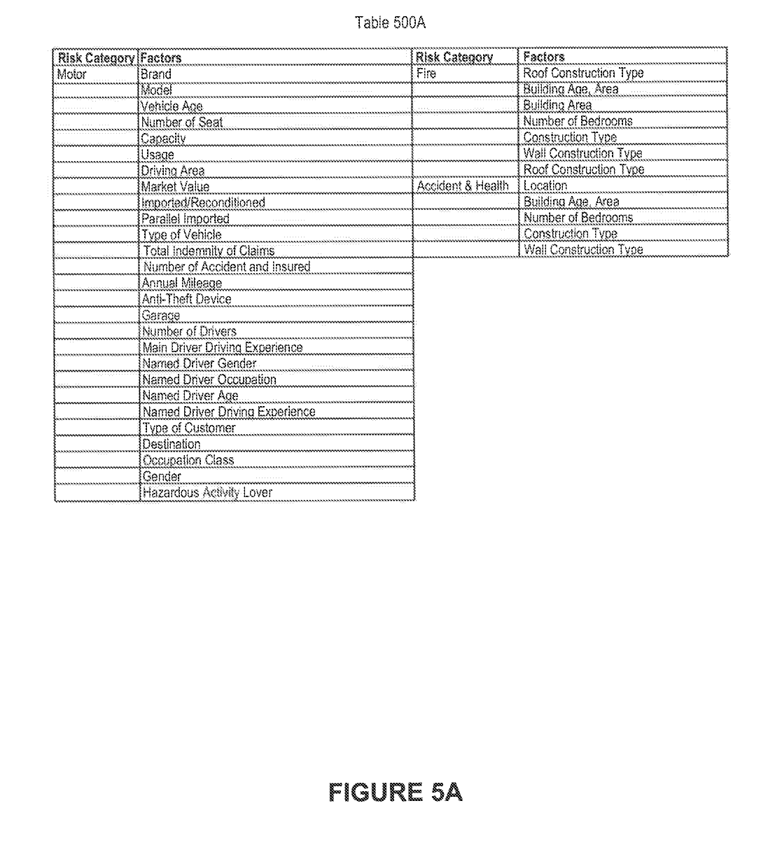

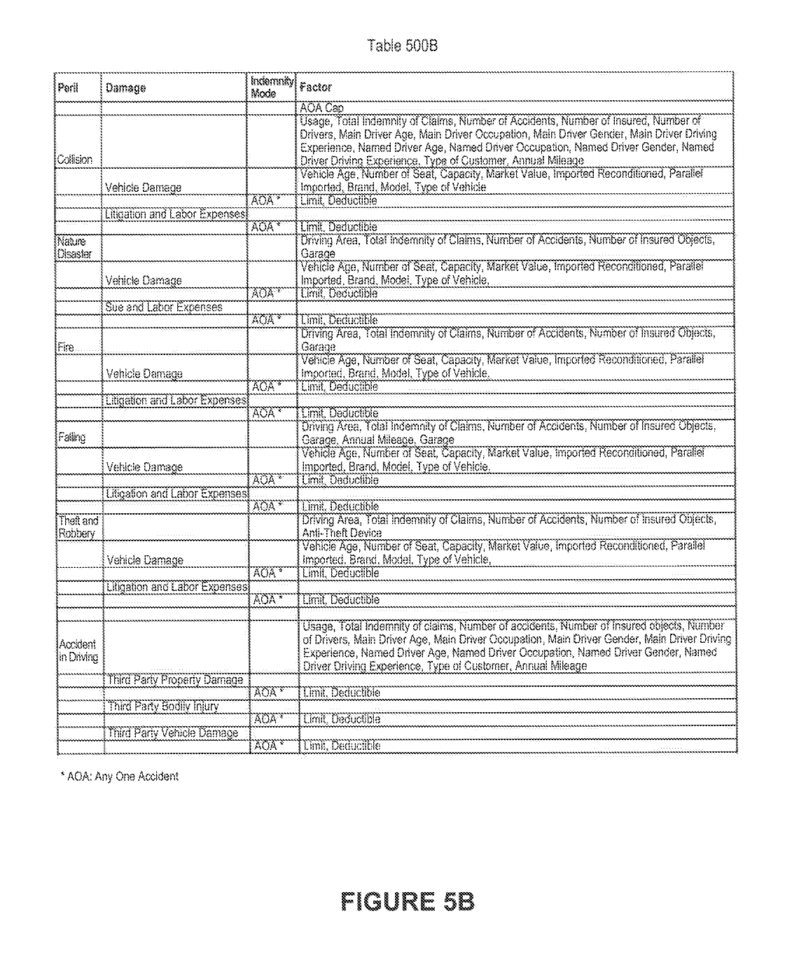

FIGS. 5A and 58 each illustrate a table including a plurality of exemplary factors associated with insurance contexts, according to some disclosed embodiments. For example, the factors illustrated in table 500A are organized based on risk categories (e.g., motor, fire, accident & health). As shown in table 500A, risk category “motor” may refer to a list of factors including brand, model, vehicle age, number of seats, capacity, usage, driving area, market value, imported reconditioned, parallel imported, etc.

As shown in FIG. 5B, the factors illustrated in table 500B are associated with a plurality of types of peril/risk (e.g., collision), and their associated damage/loss (e.g., vehicle damage) and indemnity (e.g., litigation and labor expenses). In some embodiments, the peril/risk may include various risks an individual may face daily, or various risk an entity may face in the ordinary course of business. For example, risks associated with a vehicle may include collisions, natural disasters, fire, theft, and other accidents, Factors under the peril/risk category may include, for example, information related to the insured individual and the insured property, information related to a geographic region around the insured, and past claims related to the insured as well as the geographic region, etc. For example, peril “collision” may be associated with factors such as usage, total indemnity of claims, number of accidents, number of insured, number of drivers, main driver age, main driver occupation, main driver gender, main driver driving experience, named driver age, named driver occupation, named driver gender, named driver driving experience, type of customer, and annual mileage.

In some embodiments, the damage/loss may include bodily injury (death, disability, burns, fracture, etc.), medical expense, life style maintenance, property loss, etc. For example, the damage/loss associated with a “collision” peril may include vehicle damage, litigation and labor expenses, etc, As shown in table 500B, factors associated with vehicle damage may include vehicle, age, number of seat, capacity, market value, imported reconditioned, parallel imported, brand, model, type of vehicle, etc.

In some embodiments, the indemnity may specify a compensation method for the associated damage/loss, For example, it may include an indemnity mode (compensated by Any One Accident (AOA) or by Any One Period (ADP)). As shown in table 500B, factors associated with the indemnity of vehicle damage may include, for example, the limit of compensation and a deductible.

The organization of factors in table 500A and 500B are only exemplary. It is contemplated that the factors can be organized in various other ways facilitating the retrieval of these factors from the database (e.g., database 227) for creating and managing insurance products.

Referring back to FIG. 4, in step 440, a selection of insurance context may be received, For example, the selection may be received from user 112, or user 122A/122B. The selection may specify the category of the insurance context, such as a peril/risk category, and the specific peril/risk, such as “collision.” Factors that are associated with the selected insurance context may be identified, in step 450. The associated factors may be identified from the database where the factors and associations are stored in step 430, For example, factors associated with “collision” as listed in table 500B may be identified. In step 460, the associated factors may be provided, e.g., displayed to user 112.

In some embodiments, process 400 may further include step 460 where one or more factors are updated, Updating a factor may include adding, deleting, or modifying the factor, in some embodiments, insurance software provider 110 may update the factor based on analytics it obtains on existing insurance products, and/or feedback provided by insurance companies 120A and 120B. For example, insurance company 120A may discover that an additional factor may affect the pricing of insurance coverage on hailstorm and may communicate that to insurance software provider 110 to have the factor added to the database, The updated factor may be associated or re-associated with the corresponding insurance contexts (step 420), and stored in the database (step 430).

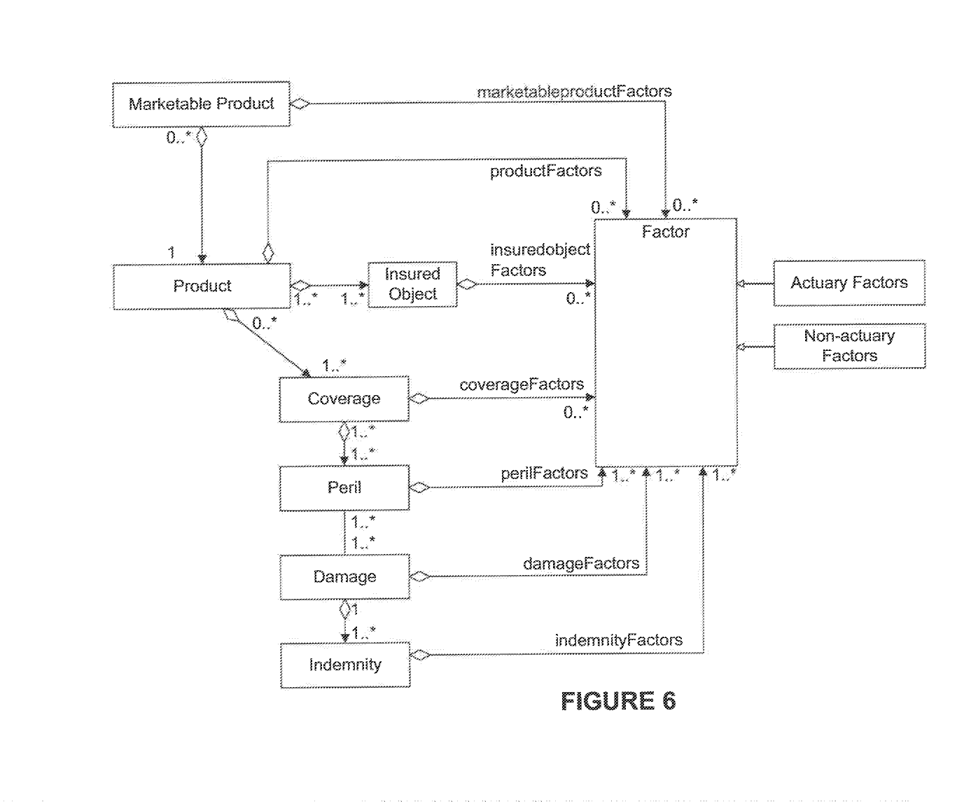

FIG. 6 illustrates a flow diagram of an exemplary process for creating insurance products from standard factors, according to some disclosed embodiments. In some embodiments, insurance companies 120A and 120B may perform that process using insurance design software provided by insurance software provider 110. As shown in FIG. 6, the insurance design software may include a database that stores the standard factors, including, for example, actuary factors and non-actuary factors. Insurance companies 120A and 120B may first select/create insurance contexts including peril, damage, and indemnity, each of which refers to one or more factors in the database.

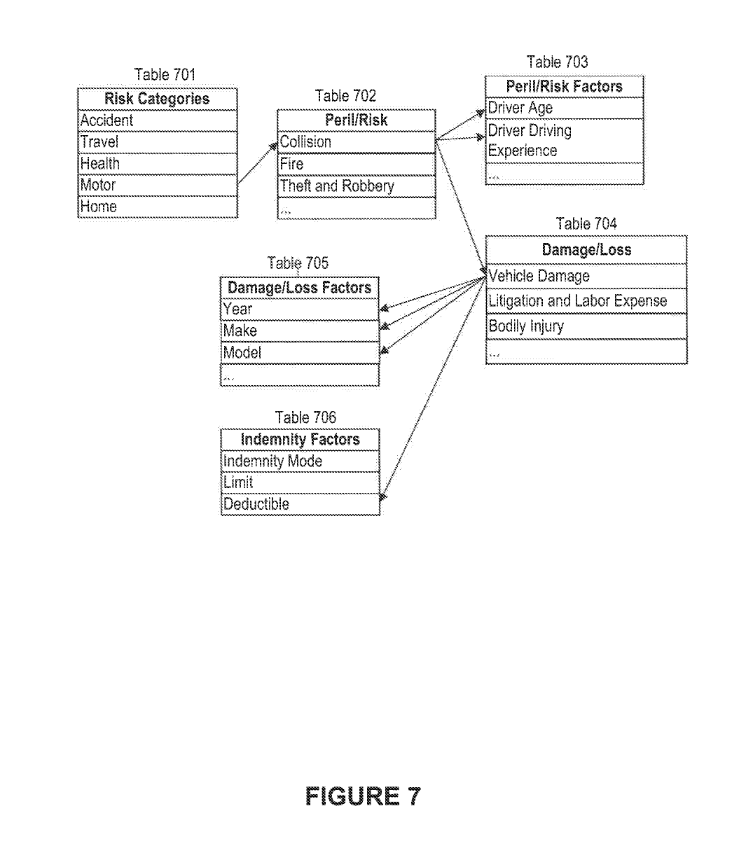

FIG. 7 illustrates exemplary associations among peril, damage, indemnity and standard factors, according to some disclosed embodiments. Table 701 shows a plurality of insurance product lines. For example, the risk categories may include, for example, accident, travel, health, auto, home, and etc. Each risk category may be associated with a plurality of possible peril/risk. For example, as shown in table 702, a “motor” type risk may cover perils including collision, fire, theft and robbery, etc. In some embodiments, table 702 may be linked to the entry “motor” in table 701, such that once “motor” is selected during coverage design, perils listed in table 702 may be automatically retrieved and provided as the available perils.

In some embodiments, each particular peril/risk in table 702 may be associated with one or more risk factors. For example, as shown in table 703, “collision” may be associated with factors including age of the driver, and driving experience of the driver, etc. In addition, each particular peril/risk in table 702 may also be associated with a plurality of damages/losses. For example, table 704 illustrates a number of possible damages/losses associated with a “collision,” including vehicle damage, litigation and labor expense, and bodily injury, etc. In some embodiments, table 704 may be linked to the entry “collision” in table 702, such that once “collision” is selected during coverage design, damages/losses listed in table 704 may be automatically retrieved and provided as the available damages/losses.

In some embodiments, each particular damage/loss in table 704 may be associated with a plurality of factors. For example, “vehicle damage” in table 704 may be associated with factors such as year, maker, and model of the vehicle, as shown in table 705. In addition, each particular damage/loss in table 704 may also be associated with a plurality of indemnity factors. For example, table 706 illustrates a number of possible indemnity factors associated with “vehicle damage” in table 704, such as indemnity mode, limit, and deductible, etc. In some embodiments, tables 705 and 706 may be linked to the entry “vehicle damage” in table 704, such that once “vehicle damage” is selected during coverage design, damage/loss factors listed in table 705 and indemnity factors listed in table 706 may be automatically retrieved and provided.

Referring back to FIG. 6, insurance companies 120A and 120B may assemble insurance coverage using the selected peril, damage, and indemnity. As a result, the created coverage is associated with the aggregated list of factors that are associated with the peril, damage, and indemnity. Insurance companies 120A and 1208 may then create an insured object, based on the associated factors.

On the next level, insurance companies 120A and 120B may create an actuary product by assembling the insurance coverage with the insured object. Consequently, the created actuary product is associated with the aggregated list of factors that are associated with the peril, damage, indemnity, and insured object. Insurance companies 120A and 1208 may further create one or more marketable products by segmenting the actuary product. For example, insurance companies 120A and 1208 may set predetermined values or ranges of values for certain factors. Therefore, each marketable product is associated with the aggregated list of factors that are associated with the peril, damage, indemnity, and insured object, where some of the factors have preset values and the remaining factors still have unknown values.

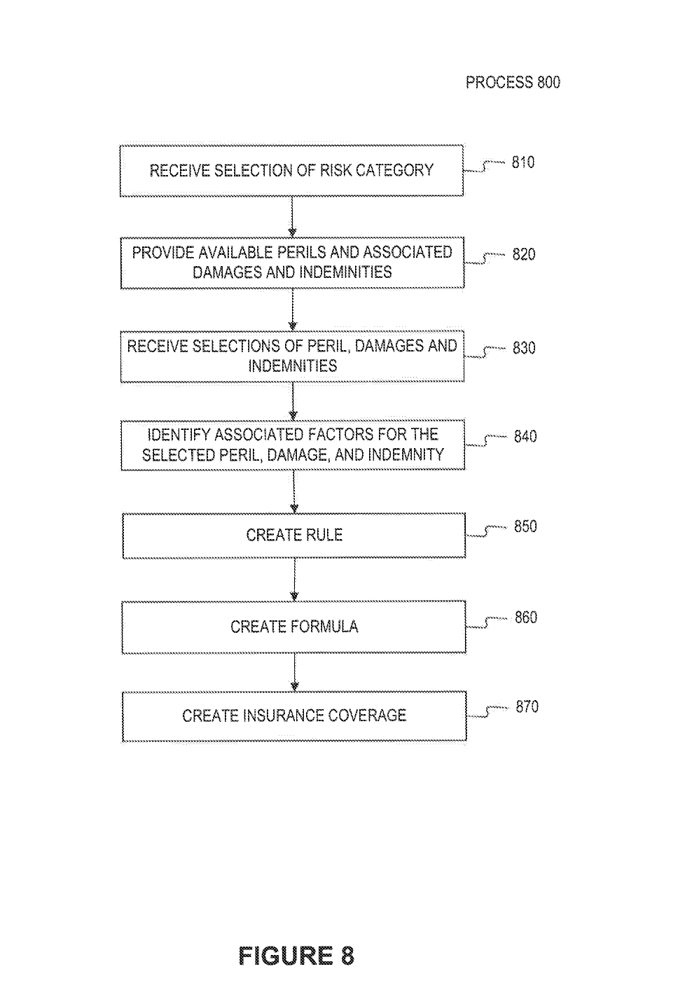

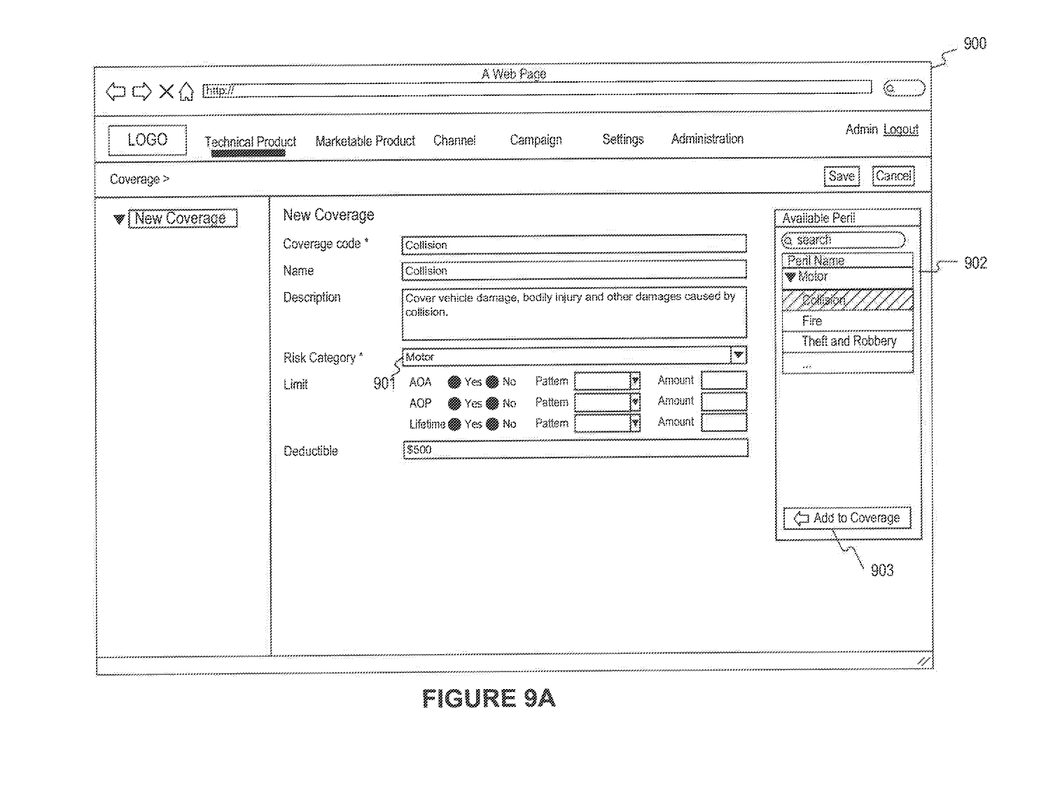

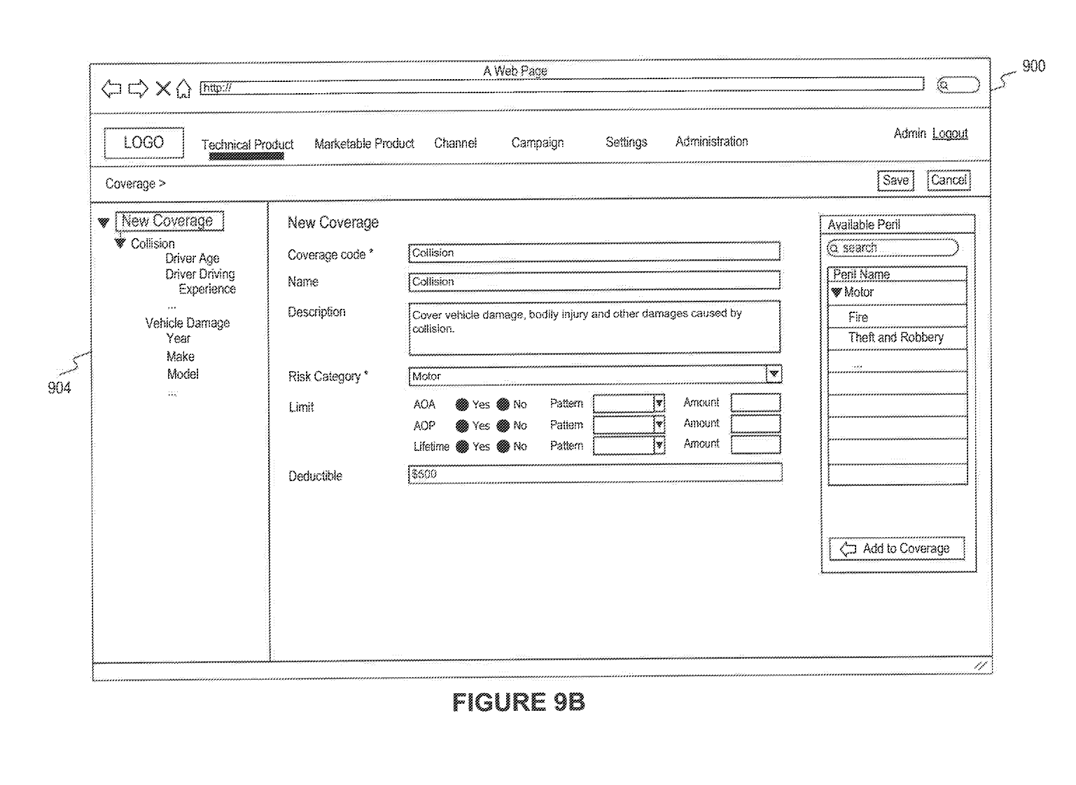

FIG. 8 illustrates a flow chart of an exemplary process 800 for creating an insurance coverage, according to some disclosed embodiments. FIGS. 9A and 9B each illustrate an exemplary interface 900 for creating an insurance coverage, according to some disclosed embodiments. Process 800 starts upon receiving a selection of a risk category in step 810, As shown in FIG. 9A, user 120A/1208 may select the “motor” risk category from a drop-down list 901 on interface 900.

Upon receiving the selection of the risk category, process 800 may identify and provide available perils and their associated damages and indemnities in step 820. In some embodiments, as shown in FIG. 9A, the available perils and associated damages may be shown in a display panel 902 on interface 900. For example, for the selected risk category “motor,” display panel 902 may show available perils “collision,” “fire,” and “theft and robbery.” The available perils and associated damages and indemnities may be obtained, for example, from tables 702, 704 and 706.

Referring back to FIG. 8, process 800 may receive selections of at least one peril type, at least one damage type, and/or at least one indemnity type. In some embodiments, a user may select the peni type, for example, by clicking on the displayed peril items in display panel 902. For example, as shown in FIG. 9A, “collision” may be selected and become highlighted on display panel 902. The user may then click on “add to coverage” button 903 to add the selected items to the new coverage, For example, selected perils and their corresponding damage items such as “vehicle damage” may be shown in display panel 904 in FIG. 9B, after being added to the coverage.

In some embodiments, a user may make indemnity type selections by checking the appropriate boxes and click on appropriate items from the drop-down lists shown on interface 900. For example, the user may select between “yes” and “no” on whether to apply AOA limit, AOP limit, and lifetime. If any of these selections is “yes,” the user may be allowed to make a further selection from the corresponding drop-down list. For example, if the user selects “yes” on AOA limit, he may further select an AOA limit pattern and an AOA amount from the drop-down lists. The user may also input an amount for the deductible on interface 900.

Referring back to FIG. 8, upon receiving the selections of peril, damage and indemnity types, process 800 may proceed to identify associated factors for the selected combinations of peril, damage, and indemnity in step 840. In some embodiments, the associated factors may be obtained from tables 703, 705, and 706, stored in database 227. In some embodiments, the associated factors may be displayed on interface 900, for example, in display panel 904 of FIG. 9B, under the corresponding perils and damages.

Process 800 may include a step 850 where an insurance-related rule is created based on one or more of the identified factors. In some embodiment, the rule may set one or more conditions for accepting or rejection an insurance application. For example, the rule may be created based on the factor “driver age” shown in display panel 904 of FIG. 9B and the condition may be that the factor “driver age” has to have a value larger than 40 for the application to be accepted.

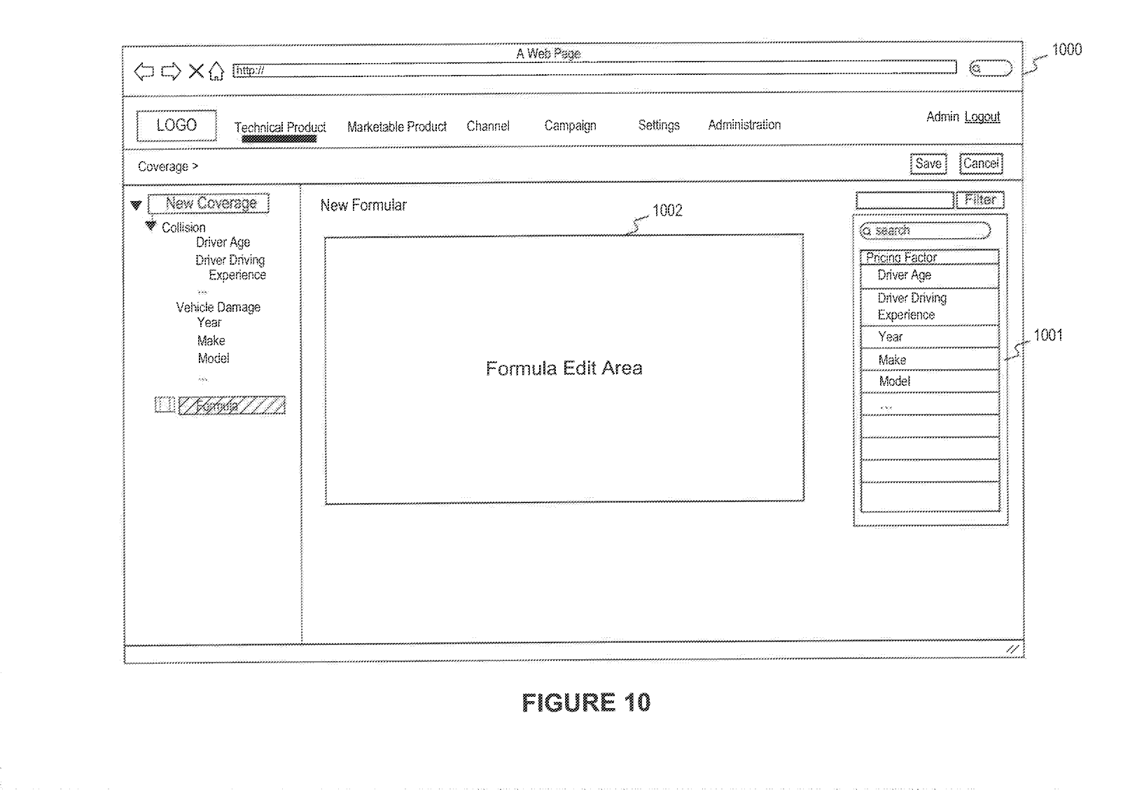

Process 800 may also include a step 860 where an actuary formula is created based on one or more of the identified factors, In some embodiments, the formula may be used for calculating an insurance premium. FIG. 10 illustrates an exemplary interface 1000 for creating a formula for insurance coverage, according to some disclosed embodiments. As shown in FIG. 10, a list of identified factors, including driver age and driver driving experience associated with “collision,” and year, maker, and model of the vehicle associated with “vehicle damage,” may be shown in a display panel 1001. In some embodiments, the user may select one or more factors from this factor list to be included in the actuary formula. For example, the user may select a factor by clicking on it, or dragging it into formula edit area 1002. The user may edit the formula in formula edit area 1002.

As an example, premium associated with a certain coverage may change based on the values of the standard factors. As an example, pricing rate of an auto coverage may be determined based on a combination of two factors: annual mileage of the car and driver's driving experience. For example, if the driver has less than a year driving experience, whereas another driver has over five-year experience of driving, prices for these two technical products may be different.

Referring back to FIG. 8, it is contemplated that process 800 may optionally include additional steps for creating other insurance related standard components, such as creating one or more insurance clauses, After these standard insurance components are created, process 800 may create insurance coverage in step 870 by assembling the components. For example, the processor may assemble the created standard peril, damage, and indemnity, and also the rule, formula and clause. In some embodiments, the insurance coverage may be created and stored as metadata.

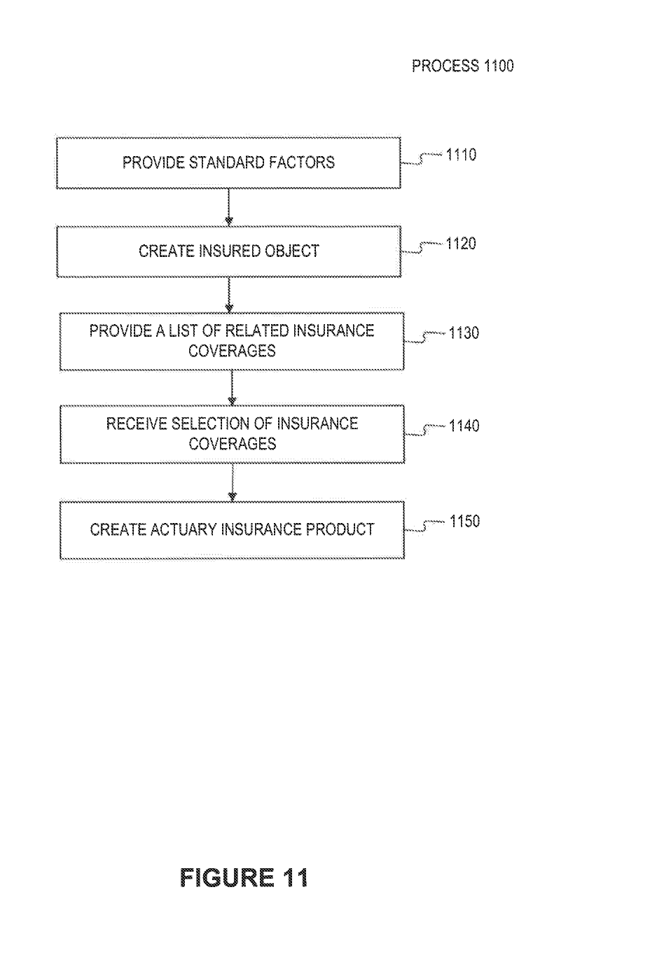

FIG. 11 illustrates a flow chart of an exemplary process 1100 for creating an actuary insurance product, according to some disclosed embodiments. For example, insurance companies 120A and 120B may use insurance design software provided by insurance software provider 110 to perform process 1100 to create actuary products. In step 1110, the insurance design software may provide a list of standard factors. In step 1120, process 1100 may create an insured object. In some embodiments, the insured objects may also be previously created and provided in a database. A user may select an insured object and the insurance design software may identify, from the database, factors that are associated with the selected insured object. Metadata for the insured object may then be created based on these associated factors.

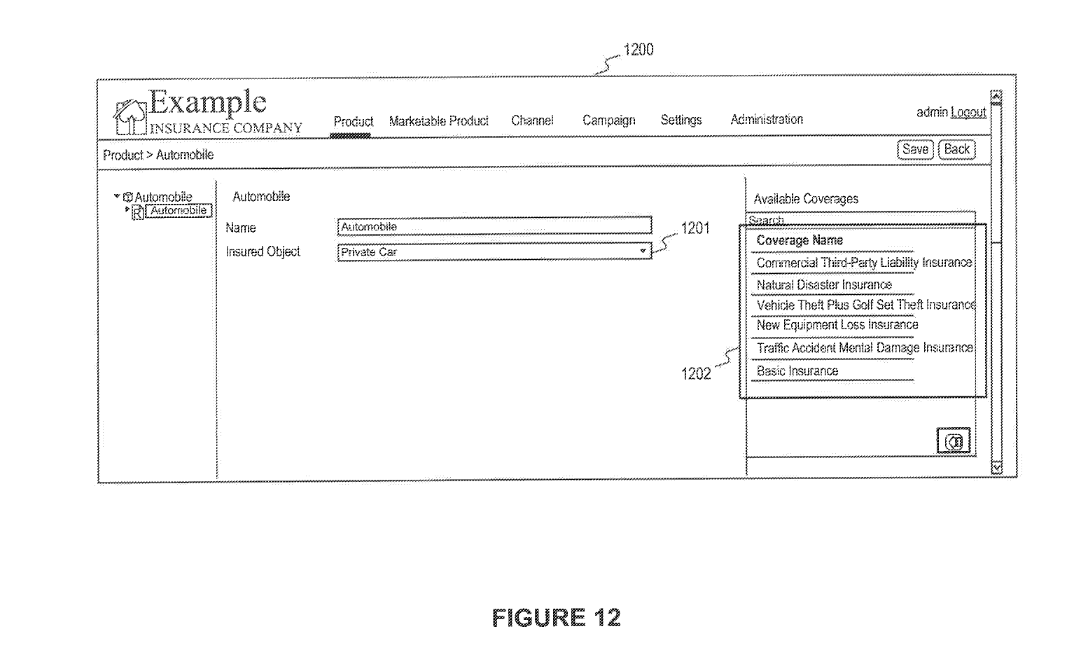

FIG. 12 illustrates an exemplary interface 1200 for creating an actuary insurance product, according to some disclosed embodiments. In some embodiments, interface 1200 may include a drop-down list 1201 for a user to select an insured object. For example, as shown in FIG. 12, the user selects “private car” as the insured object. Accordingly, the insurance design software may provide a list of standard factors associated with a “private car,” according to predefined associations stored in database 227. In some embodiments, the insurance design software may then create metadata for this insured “private car” based on the associated factors.

Referring back to FIG. 11, process 1100 may provide a list of insurance coverages related to the created or selected insured object in step 1130. In some embodiments, these insurance coverages may be previously created using process 800. For example, FIG. 12 shows an exemplary list of coverage names in a display panel 1202 that are related to the insured object “private car.”

Process 1100 may receive a selection of one or more insurance coverages in step 1140. In some embodiments, the user may select coverages from the list shown in display panel 1202 to be included in the actuary product. For example, the user may select a coverage by clicking on it. In step 1150, process 1100 may then create the actuary product by assembling metadata of the selected coverages with the metadata of the insured object. For example, as shown in FIG. 12, an automobile insurance product may be created by assembling metadata for “private car” and metadata for certain selected coverages, such as “natural disaster insurance,” and “traffic accident mental damage insurance.”

Depending on the relationship between the insured object and the coverage, various types of actuary products may be created. For example, an actuary product can have one insured object paired with one set of coverage. As another example, a technical product can have more than one insured object paired with one set of coverage. If more than one insured object is paired with one set of coverage, depending on whether the insured objects have the same instance value, the actuary product may be a group product (multiple insured objects share one instance value of coverage) and a multiple insured product (multiple insured objects have individual instance values of coverage). In an exemplary embodiment, an actuary product may also include multiple risk categories.

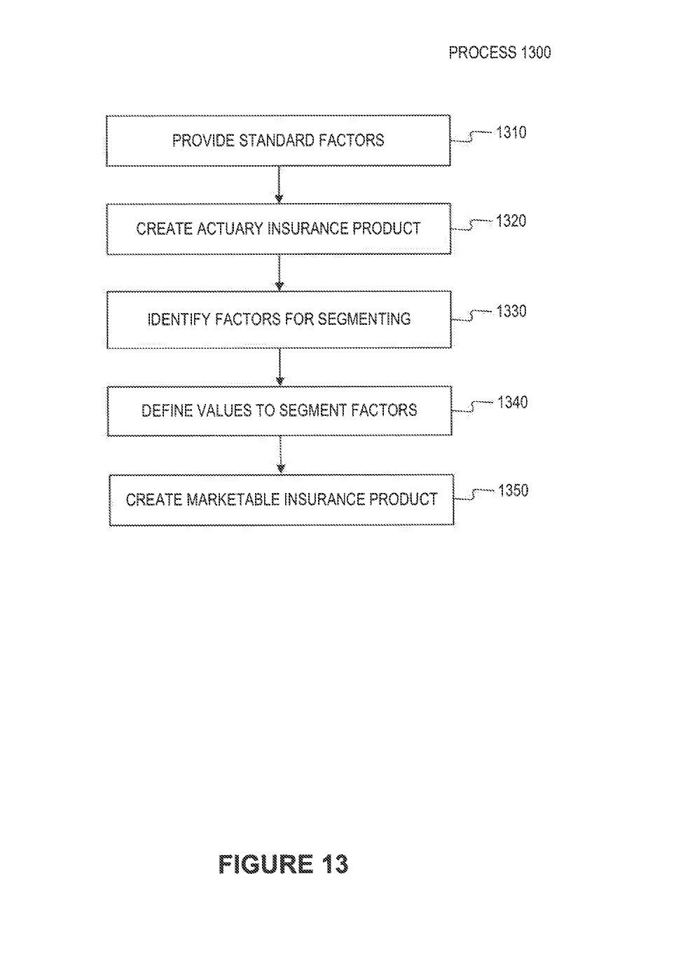

FIG. 13 illustrates a flow chart of an exemplary process 1300 for creating a marketable insurance product, according to some disclosed embodiments. For example, insurance companies 120A and 120B may use insurance design software provided by insurance software provider 110 to perform process 1100 to create actuary products. In step 1310, the insurance design software may provide a list of standard factors. In step 1320, process 1300 may create an actuary insurance product. In some embodiments, the actuary insurance product may be created using process 1100.

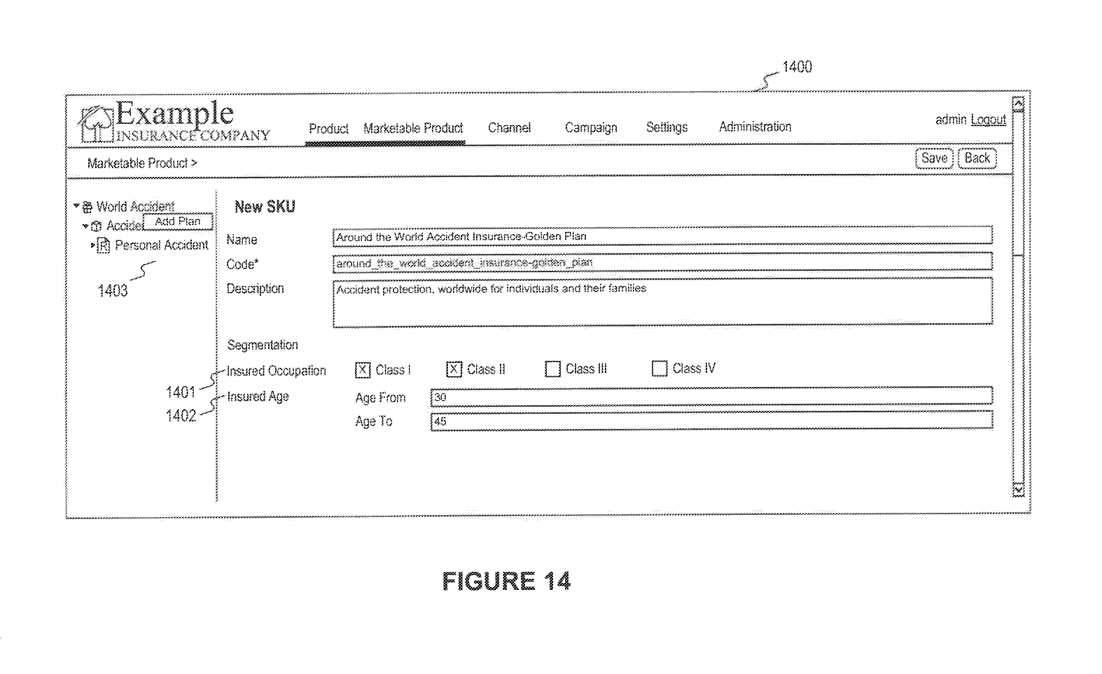

In step 1330, process 1300 may identify one or more factors for segmenting. In some embodiments, the factors to be segmented may be indicated by a user on an interface. FIG. 14 illustrates an exemplary interface 1400 for creating a marketable insurance product, according to some disclosed embodiments. For example, interface 1400 may include areas 1401 and 1402 for user to identify factors to be segmented. As shown in FIG. 14, the factors for segmenting include insured occupation and insured age.

In step 1340, process 1300 may define values or ranges of values for the factors. In some embodiments, a user may specify these values or ranges of values on an interface, For example, area 1401 may include check boxes for the user to select the insured occupation. Area 1402 may include input fields for the user to type in value ranges for the driver's age, e.g., from 30 to 45. Once the values and ranges of values are set for the selected factors, a marketable product has been created in step 1350. Accordingly, the marketable product may include data (i.e., preset values) for the segmented factors and metadata for the remaining factors.

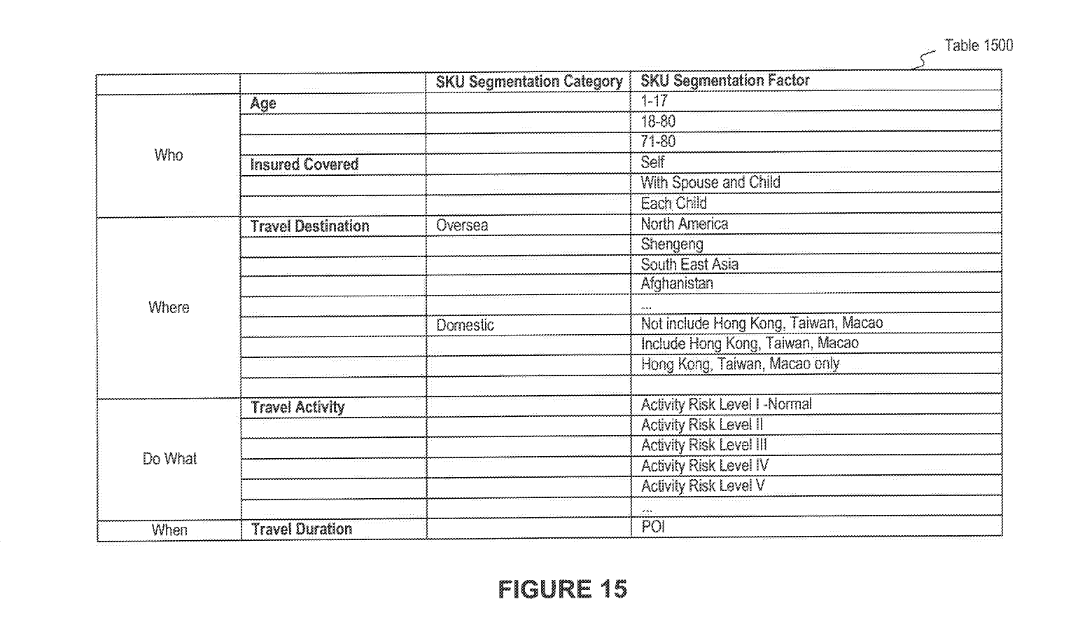

FIG. 15 illustrates a table 1500 containing exemplary predetermined factors for segmenting a travel insurance product, according to some disclosed embodiments. For example, the segmented factors may be associated with the insured object (who), the target travel region of the insured object (where), the covered activities (do what), and the travel duration (when). As shown in table 1500, the age of the insured traveler may be set to ranges such as 1-17, 18-80, and 71-80 to have the product target different demographic markets. Further, the number of insured travelers may be set to one (self), or multiple (e.g., with spouse and child) to target single, or married people. As other examples, travel destinations may be set to various domestic as well as foreign cities. Marketable products may be later distributed specifically to the target markets.

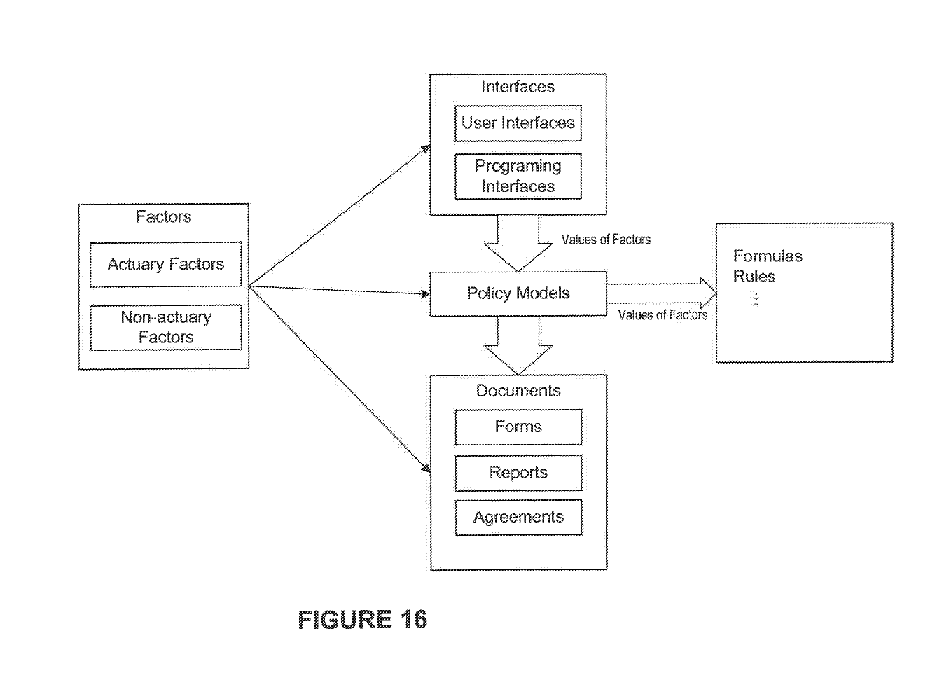

FIG. 16 illustrates a flow diagram for creating various insurance-related templates and other documents based on the standard factors, according to some disclosed embodiments. For example, for an insurance product designed using process 1100 or 1300, the factors associated with the peril, damage, indemnity, and insured object, selected for such an insurance product, may be used to create the insurance-related templates, Consistent with the embodiments, the insurance-related templates may be created automatically by insurance company 120A/120B or client 130.

In yet some embodiments, the insurance-related template may be a discovery interface for retrieving metadata of the factors associated with a particular insurance product. For example, the discovery interface may be a programing interface, such as an application programming interface (“API”), In some embodiments, the discovery interface may retrieve metadata that indicate the data types of the factor values, e.g., number, percentage, text, date, currency, etc., and the data length, e.g., number of digits after the decimal.

In some embodiments, the insurance-related template may be an interface created for receiving inputs of values for the various factors associated with a particular insurance product. The interface may include various fields for receiving the inputs. In some embodiments, the interface may be designed based on the metadata retrieved by the discovery interface. For example, for receiving an integer number type factor value, the interface may include a field that takes only integer numbers. If texts are input in that field, the input may be rejected and the user may be prompted to input again. If an non-integer number is input in that field, the user may be prompted to input a valid integer number, or the non-integer number may be automatically rounded to the closest integer number.

In some embodiments, the interface may be a user interface (“UI”) or a graphic user interface (“GUI”) for receiving inputs from a user, such as user 132 for certain factors. For example, the UI or GUI may include check boxes, dropdown lists, input fields, or other types of fields for receiving user inputs. A user may input user-specific information, such as name, gender, age, location, driving experience of a driver, and mileage, age, and model of a car. The user may also input coverage-specific information, such as a choice of a deductible level.

In some other embodiments, the interface may also be a programing interface for receiving input values from a service. For example, the programing interface may be an API. The input values of certain factors may be obtained from a service such as a database, a form, or other another type of public or private data source. Such factors may include, for example, number of claims in past 3 years or credit score of the insured person, etc.

In some embodiments, the insurance-related template may be an insurance policy model template created based on the associated factors. For example, a policy model template for a particular insurance product may be created based on the factors identified as associated with that insurance product. The policy model template may include various fields to store values of the associated factors that are to be provided. When the fields are filled in with specific values, the insurance policy model template becomes an actual insurance policy model.

In some embodiments, the insurance-related template may also be a document created based on the associated factors. The document may include various fields to store values of the associated factors that are to be provided. For example, the document may be a template of a clause, a template form, a template report, a template insurance card, and etc.

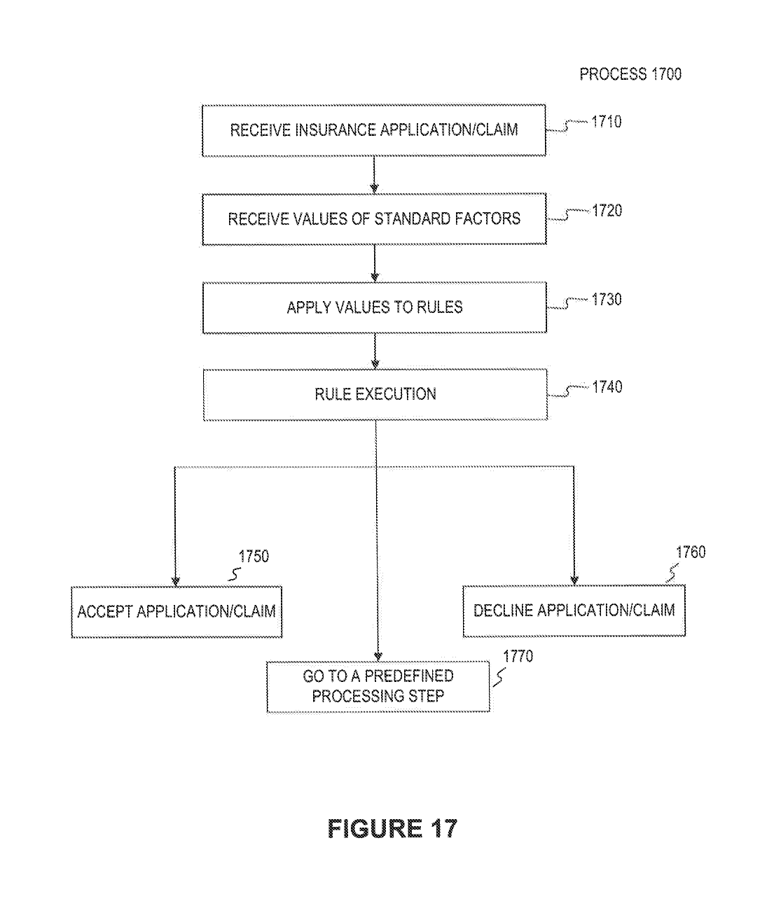

FIG. 16 further illustrates the flow of and use of factor values, which will be described in more details in connection with FIGS. 17-19. In general, as shown in FIG. 16, factor values may be input and received by the interfaces. The values may then be used to fill in the fields in those policy model templates to generate actual policy models. The values may further flow to fill in the fields of the documents, to generate actual forms, reports, and agreements, etc. The values may also be plugged into the insurance components, such as formulas, rules, and clauses. For example, premiums may be calculated when the values are applied to a formula. As another example, boundaries of the conditions may be set in the rules, so that the rules may be used to determine whether a particular application should be accepted or declined.

FIG. 17 illustrates a flow chart of an exemplary process 1700 for processing an insurance application/claim, according to some disclosed embodiments. In some embodiments, process 1700 may start when an insurance application is received in step 1710. An insurance application may be a new application to apply for an insurance policy, a renew application to renew an existing insurance policy, or an endorsement application to request insurance endorsement.

In step 1720, process 1700 may receive values of various factors associated with the insurance product being applied for. For example, the values may be predefined by insurance company 120A/120B or insurance software provider 110 and pre-programed into the insurance design software, or input by the applicant via a UI, or obtained directly from a service by insurance company 120A/120B or client 130. In some embodiments, the values may be for factors associated with the insured object, such as a person, a car, a house, and etc.

Process 1700 may then compare one or more of the input values with a rule, in step 1730. As disclosed previously in connection with FIG. 3, the rule may set one or more conditions for accepting or rejection an insurance application. In some embodiments, the rule may specify a value or a range of values for a certain factor. For example, the rule associated with a particular insurance product may specify that the age of the applicant has to be over 40 years old, or the driving experience of the application has to be over 2 years, or the location of the applicant's house is within a particular region (e.g., in the state of Maryland). The input values may be compared with the specified value or value range to determine whether the applicant satisfies the rule (step 1740).

If it is determined that the rule is satisfied, the application may be accepted by insurance company 120A/120B in step 1750. Otherwise, the application may be rejected in step 1760 or forwarded to a predefined step for further processing in step 1770. For example, the application may be forwarded to an employee of insurance company 120A/120B for manual processing.

In some alternative embodiments, process 1700 may start when an application for filing an insurance claim is received. The application may be submitted by an insured (e.g., in a health insurance or a travelers insurance), owner of the insured (e.g., in an auto insurance or a home insurance), or a third-party beneficiary (e.g., in a life insurance, or an auto insurance).

In step 1720, process 1700 may receive values of various factors associated with the insurance policy being claimed for. In some embodiments, the values may be for a risk, one or more damages, one or more insured objects, or the third-party as well as factors associated with. For example, an application to file a claim against an auto insurance policy, the inputs may include the type of accident (e.g., a collision accident), the type of damage (e.g., property damage of a vehicle involved in the collision), and the people involved in the accident (e.g., the drivers of the vehicles that collided with each other).

Process 1700 may then compare one or more of the input values with a rule, in step 1730. For example, the rule associated with a particular insurance policy may specify that property damage of a vehicle involved in a collision accident with an uninsured is covered up to $30,000, or that a cancellation of a cruise sailing due to purely weather conditions is not covered if the length of the canceled sailing is less than 2 days. The input values may be compared with the specified value or value range to determine whether the applicant satisfies the rule (step 1740).

If it is determined that the rule is satisfied, the claim may be accepted by insurance company 120A/120B in step 1750. Otherwise, the claim may be rejected in step 1760 or forwarded to a predefined step for further processing in step 1770. For example, the claim may be forwarded to an employee of insurance company 120A/120B for manual processing.

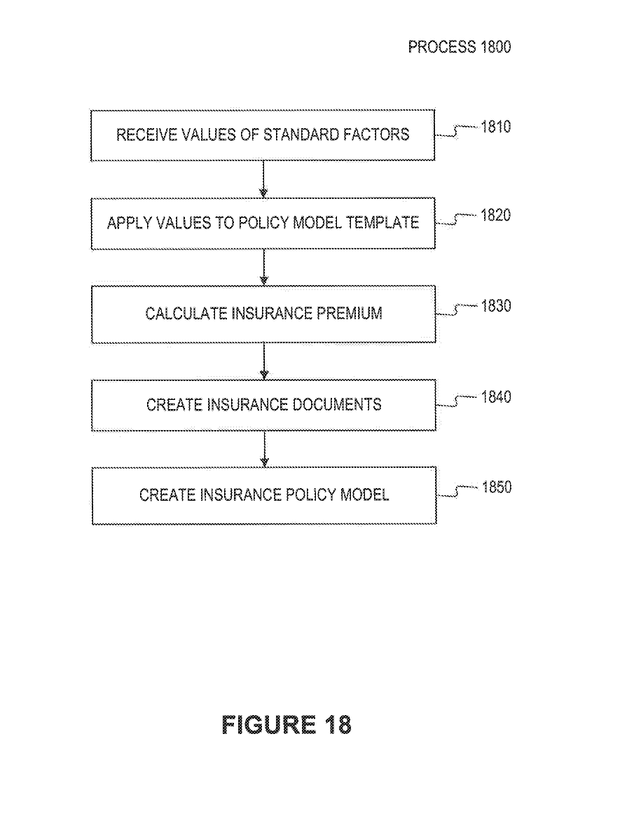

FIG. 18 illustrates a flow chart of an exemplary process 1800 for creating an insurance policy model, according to some disclosed embodiments. Process 1800 may start when values of the various factors associated with the insurance policy are received in step 1810. In some embodiments, the values may be predefined by insurance company 120A/120B or insurance software provider 110 and pre-programed into the insurance design software, or input by the applicant via a UI, or obtained directly from a service by insurance company 120A/120B or client 130.

In step 1820, the values may be applied to an insurance policy model template. As disclosed previously in connection with FIG. 3, the insurance policy model template is a template insurance policy with fields to store values of the associated factors that are to be provided. Applying the values to the insurance policy model template may include storing the values in the respective fields of the policy model template.

Based on the values, certain insurance calculations may be performed in step 1830. In some embodiments, the insurance calculation may include calculating a premium for the policy based on a formula. In some other embodiments, the calculation may alternatively or additionally include calculating a discount on the premium for a particular buyer. In yet some other embodiments, the calculation may include calculating a commission to be paid to an insurance agent or distributor for selling or distributing the insurance policy to a buyer. After the values are applied to the policy model template and the calculations are performed, related insurance documents may be created in step 1840 and an insurance policy model may be created in step 1850.

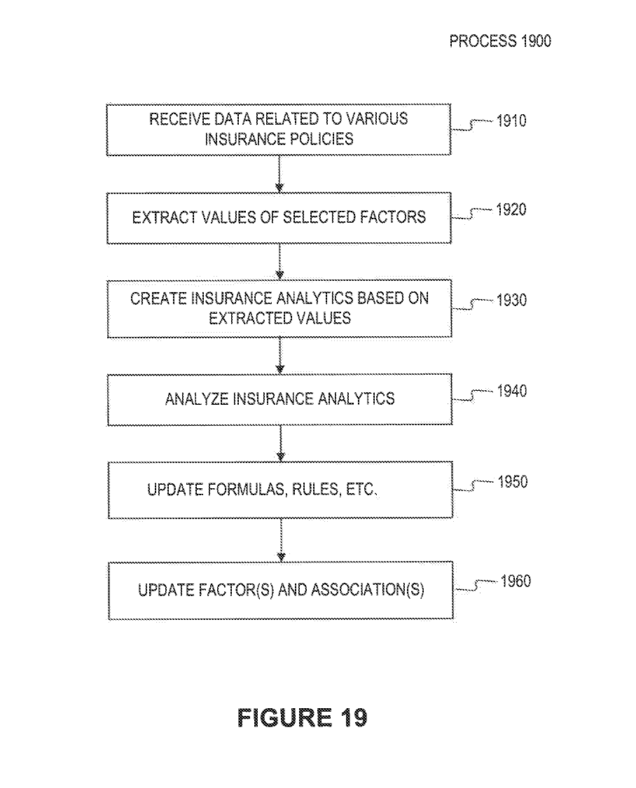

FIG. 19 illustrates a flow chart of an exemplary process 1900 for creating insurance analytics, according to some disclosed embodiments. Insurance software provider 110 or insurance company 120A/120B may perform process 1900 to create insurance analytics on a routine basis to collect statistics of factors used in insurance policies created by the insurance design software. Based on the statistics, insurance software provider 110 or insurance company 120A/120B may evaluate performance of the insurance design software and improve the software.

In some embodiments, process 1900 may start when a plurality of insurance policies are received in step 1910. For example, the insurance policies may be created using process 1800. In particular, data and metadata related to the factors associated with the insurance policies are received. In some embodiments, data related to claims filed against the insurance policies may also be received.

In step 1920, the values of the factors may be extracted from the received insurance policies. For example, multiple auto insurance policies issued to various households for cover their respective vehicle(s) may be received in step 1910, and the ages of the vehicles may be extracted from these policies in step 1920. Other values, such as mileages of the vehicles, locations of the vehicles, driving experience of the drivers, may also be extracted in step 1920. In some embodiments, data related to coverage selections may also be extracted, such as comprehensive or liability only, compensation limits on property damage, deductible levels on collision, etc, In some embodiments, data related to filed claims may also be extracted.

Alternative to steps 1910 and 1920, process 1900 may receive the values of the factors directly from a database, where the factors used in a plurality of insurance policies are stored.

In step 1930, insurance analytics may be created based on the extracted values. In some embodiments, the extracted values may be processed and analyzed in step 1930. For example, statistical calculations, such as regressions, interpolations, averaging, clustering, etc., may be performed on the extracted values. For example, the analytics may provide the average or median mileage of insured vehicles, and a standard deviation to indicate the variance in mileages among the insured vehicles. As another example, the statistics may provide a distribution of the driving experience, such as 10% of the drivers have less than a year of driving experience, 30% have 1-3 years of driving experience, 40% has 3-5 years of driving experience, and 20% has more 6 years of driving experience.

In some embodiments, correlations between values of two or more factors may be calculated as part of step 1930. For example, correlations between age of the vehicle and selection of comprehensive coverage may be calculated. As another example, correlations between driving experience of the driver and the selection of a relatively high deductible (e.g., $1000 for collision accident) may be calculated. In some embodiments, correlations between factor values and the frequency of filing claims may also be determined.

The insurance analytics may be used by insurance software provider 110 or insurance company 120A/120B in various ways to improve the insurance design software of the insurance design processes. For example, in step 1940, insurance software provider 110 or insurance company 120A/120B may analyze the insurance analytics, and determine that one or more formulas and/or rules need to be updated. Additionally or alternatively, insurance software provider 110 or insurance company 120A/120B may find that one or more factors need to be updated.

The one or more formulas and/or rules may be updated in step 1950, and insurance software provider 110 or insurance company 120A/120B. For example, in step 1940, a factor may be discovered as to have a greater influence insurance pricing than initially estimated. Accordingly, the formula may be updated in step 1950 to increase the weight of that particular factor. As another example, a rule may initially specify that only insurance applicants older than 60 years are qualify for purchasing a certain product. However, in step 1940, it may be found that including applicants are slightly younger may in fact improve profitability of the product. Accordingly, the rule may be changed to reflect this founding.

In some embodiments, the one or more factors may be updated in step 1960 by insurance software provider 110. For example, in step 1940, a new factor may be discovered as to affect the pricing of the insurance product, and therefore should be added to the database. The new factor may be associated with the insurance contexts, such as risk, damage, indemnity, and insured object in step 1950. As another example, in step 1940, the values of an existing factor may be found to be correlated with more or less insurance contexts, and therefore the association between the factor and the insurance contexts should be amended. For example, factor “driving area” may be previously associated with risks such as “natural disaster,” “fire,” “falling,” “theft and robbery,” etc. The analytics created in step 1930 may later indicate that the factor is also correlated with risk “collision.” Accordingly, the factor may be updated and associated with risk “collision” in step 1960.

Other embodiments of the invention will be apparent to those skilled in the art from consideration of the specification and practice of the invention disclosed herein. The scope of the invention is intended to cover any variations, uses, or adaptations of the invention following the general principles thereof and including such departures from the present disclosure as come within known or customary practice in the art. It is intended that the specification and examples be considered as exemplary only, with a true scope and spirit of the invention indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A computer-implemented method for creating an insurance product, comprising:
providing, by at least one processor, a list of factors;
creating, by the at least one processor, a first insurance product based on the list of factors; and
creating, by the at least one processor, a second insurance product by segmenting the first insurance product based on a subset of the list of factors.

2. The computer-implemented method of claim 1, wherein segmenting the first insurance product includes specifying a value or a range of values for each factor in the subset.

3. The computer-implemented method of claim 2, further comprising determining a distribution channel for the second insurance product based on the specified value or range of values of each factor in the subset.

4. The computer-implemented method of claim 1, wherein the list of factors are associated with a plurality of user-selected insurance contexts.

5. The computer-implemented method of claim 1, wherein the subset of the list of factors include one or more of a geographic scope, a timeframe, an attribute of an insured object, or an activity to be covered by the insurance product.

6. The computer-implemented method of claim 1, wherein the creating the first insurance product includes:
determining an insurance coverage based on the list of factors;
determining an insured object based on the list of factors; and
creating the first insurance product by combining the insurance coverage with the insured object.

7. The computer-implemented method of claim 1, further comprising generating a user interface based on the list of factors, the user interface including at least one field predetermined based on the specified value or range of values.

8. A system for creating an insurance product, comprising:
a storage device, configured to store a list of factors; and
at least one processor, configured to:
create a first insurance product based on the list of factors; and
create a second insurance product by segmenting the first insurance product based on a subset of the list of factors.

9. The system of claim 8, wherein segmenting the first insurance product includes specifying a value or a range of values for each factor in the subset.

10. The system of claim 9, wherein the at least one processor is further configured to determine a distribution channel for the second insurance product based on the specified value or range of values of each factor in the subset.

11. The system of claim 8, wherein the list of factors are associated with a plurality of user-selected insurance contexts.

12. The system of claim 8, wherein the subset of the list of factors include one or more of a geographic scope, a timeframe, an attribute of an insured object, or an activity to be covered by the insurance product.

13. The system of claim 8, wherein to create the first insurance product, the at least one processor is further configured to:
determine an insurance coverage based on the list of factors;
determine an insured object based on the list of factors; and
create the first insurance product by combining the insurance coverage with the insured object.

14. The system of claim 8, wherein the at least one processor is further configured to generate a user interface based on the list of factors, the user interface including at least one field predetermined based on the specified value or range of values.

15. A non-transitory computer-readable medium having instructions stored thereon, the instructions, when executed by at least one processor, performing a method for creating an insurance product, the method comprising:
providing a list of factors;
creating a first insurance product based on the list of factors; and
creating a second insurance product by segmenting the first insurance product based on a subset of the list of factors.

16. The computer-readable medium of claim 15, wherein segmenting the first insurance product includes specifying a value or a range of values for each factor in the subset.

17. The computer-readable medium of claim 16, wherein the method further comprises determining a distribution channel for the second insurance product based on the specified value or range of values of each factor in the subset.

16. The computer-readable medium of claim 15, wherein the list of factors are associated with a plurality of user-selected insurance contexts.

19. The computer-readable medium of claim 15, wherein the subset of the list of factors include one or more of a geographic scope, a timeframe, an attribute of an insured object, or an activity to be covered by the insurance product.

20. The computer-readable medium of claim 15, wherein the creating the first insurance product includes:
determining an insurance coverage based on the list of factors;
determining an insured object based on the list of factors; and
creating the first insurance product by combining the insurance coverage with the insured object.

21. The computer-readable medium of claim 15, wherein the method further comprises generating a user interface based on the list of factors, the user interface including at least one field predetermined based on the specified value or range of values.
